(19) United States
(12) Patent Application Publication
(10) Pub. No.: US 2001/0039468 A1
(43) Pub. Date: Nov. 8, 2001

(54) Control device and process for activating an airbag

(75) Inventor: Josef Seidl, Dingolfing (DE)

Correspondence Address: Evenson, McKeown, Edwards & Lenahan, P.L.L.C., Suite 700, 1200 G Street, Washington, DC, 20005, US

(73) Assignee: Bayerische Motoren Werke Akiengesellschaft.

(21) Appl. No.: 09/838,314

(22) Filed: Apr. 20, 2001

(30) Foreign Application Priority Data
Apr. 20, 2000 (DE) 100 19 590.3

(51) Int. Cl. B60R 21/32

(52) U.S. Cl. 701/45; 280/735

(57) ABSTRACT

A control device and a process for activating an airbag, in particular in one track vehicles, is provided. The control device receives and evaluates input signals and is designed so as to generate, in the presence of defined conditions, a signal, which results in the activation of an airbag. To avoid misactivation of the airbag, a sensor for detecting the revolution or a deceleration of the front wheel is provided and a suitable signal is generated. In the case of an antilocking system, an activating signal is generated. A device for detecting an application of the front wheel brake is provided and a suitable signal is generated. The signals are fed to the control device. The control device is designed so as to permit, in addition to at least one other condition, the activation of an airbag only if in the case the front wheel brake is not applied or in the case the front wheel brake is applied but the antilocking system is activated, the front wheel is decelerated in essence to zero.

### BACKGROUND AND SUMMARY OF THE INVENTION

This application claims the priority of German Application No. 100 19 590.3, filed Apr. 20, 2000, the disclosure of which is expressly incorporated by reference herein.

The invention relates to a control device and a process for activating an airbag, in particular for activating an airbag in one track vehicles such as motorcycles, bicycles, etc.

The process of activating airbags in two track vehicles, such as automobiles, trucks, etc. is universally known and is often based on signals from acceleration sensors. In addition, other vehicle operating conditions, such as skidding, etc., are also sometimes considered.

In one track vehicles, the “two track technology” cannot be employed without great effort. If with respect to airbag activation one were to rely only on the information about the longitudinal acceleration, a correspondingly high threshold would have to be set in order to avoid misactivation. Misactivations in one track vehicles have a negative impact on driving safety, namely to a very significant degree. However, too high an activation threshold results in activation that occurs too late so that the protective effect of the airbag can no longer be completely utilized.

Therefore, the object of the present invention is to provide a control device and process for activating an airbag, in particular for activating an airbag in one track vehicles. With such a device and process the aforementioned drawbacks can be avoided.

This problem is solved by providing a control device for activating an airbag, in particular in one track vehicles, which receives and evaluates input signals and is designed in such a manner as to generate, in the presence of defined conditions, a signal, which results in the activation of an airbag. A sensor for detecting the revolution of the front wheel or a deceleration of the front wheel is provided and a suitable signal is generated. If there is an antilocking system, the antilocking system generates in operation an activating signal. A device for detecting an application of the front wheel brake is provided and a suitable signal is generated. The signals are fed to the control device and the control device is designed in such a manner as to permit, in addition to at least one other condition, the activation of an airbag only if in the case the front wheel brake is not applied or in the case the front wheel brake is applied but the antilocking system is activated, the front wheel is decelerated in essence to zero. The process according to the invention solves the problem by (1) detecting the speed of a front wheel or the deceleration of the front wheel, (2) detecting the activation of an antilocking system—in case such a system is present, (3) detecting the activation of a front wheel brake, and generating a signal for activating an airbag if, in addition to at least one other condition, the front wheel is decelerated in essence to zero when the front wheel brake is not applied or when the front wheel brake is applied, but the antilocking system is activated.

One feature that is essential to the invention is consideration of the one track-specific behavior that occurs in a collision. In particular, it is tested whether the speed of the front wheel is decelerated to zero when the front wheel brake is not applied or when the front wheel brake is applied, but the antilocking system (to the extent that such a system exists) is activated. If this is the case at a vehicle speed exceeding a defined speed threshold or under other conditions, e.g. exceeding a defined deceleration threshold, one can conclude from this condition that a collision has occurred.

If a one track vehicle has an antilocking system, the airbag can be activated even when the front wheel brake is applied. To avoid a wheel lockage, the antilocking system would have to decrease the brake pressure. If despite such a reduction of the brake pressure the front wheel decelerates in essence to zero, one can conclude in turn a collision.

The deceleration of the front wheel to zero is caused in essence by the one track typical collision of the front wheel with an impediment. If in addition the rear wheel lifts off, the result is that the front wheel turns in reverse so that even in the event of a joint movement of the collided vehicles the probability of the speed of the front wheel passing through zero is high. With the combination of at least one additional condition, such as exceeding a defined driving speed threshold or exceeding a defined vehicle deceleration threshold, it is possible to achieve a reliable activation of an airbag, in particular in a one track vehicle, with the detection of a speed of zero for the front wheel or a corresponding deceleration. In particular, the activation threshold for an acceleration sensor can be set at a low valve without having to accept the risk of a misactivation. In addition, the result is better usage of the available time and a better protective effect.

Other objects, advantages and novel features of the present invention will become apparent from the following detailed description of the invention when considered in conjunction with the accompanying drawings.

### BRIEF DESCRIPTION OF THE DRAWINGS

FIG. 1 is a simplified block diagram of one embodiment of the present invention; and

FIG. 2 is a flow diagram, which represents an algorithm that can be selected to operate a device, according to FIG. 1.

### DETAILED DESCRIPTION OF THE DRAWINGS

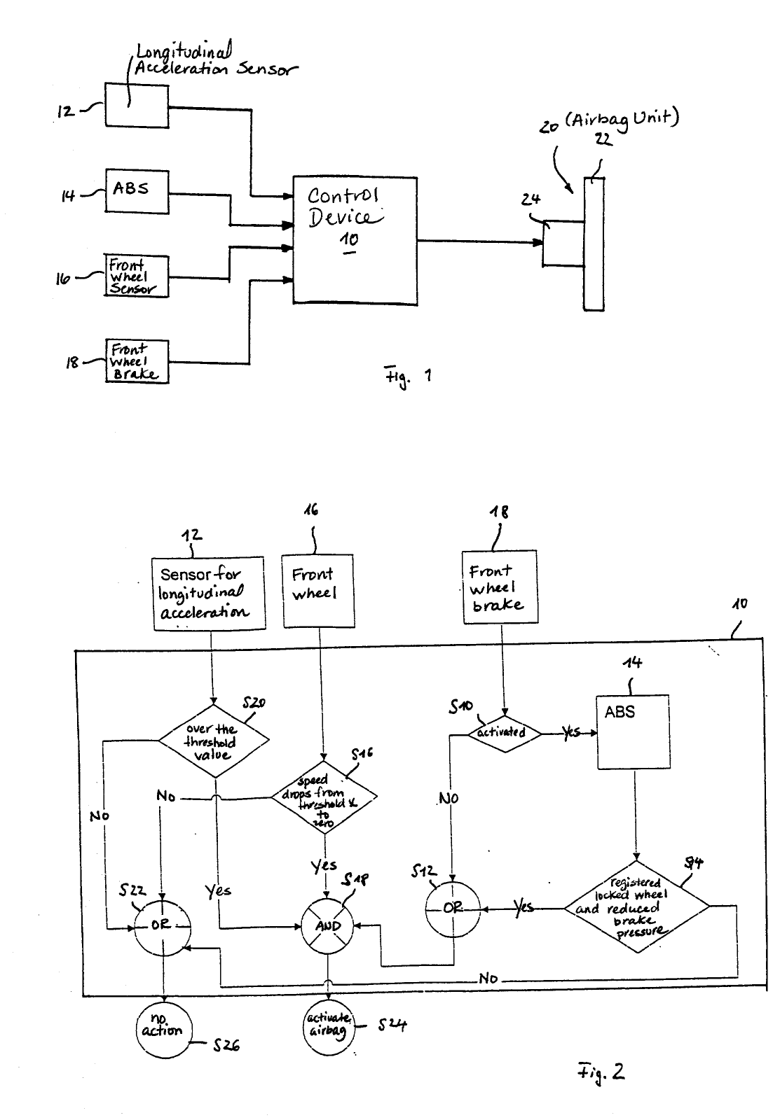

FIG. 1 is a very simple block diagram of a control device 10, which is provided with input signals from four sensors or units.

The four sensors or units are a sensor to determine the longitudinal acceleration 12; an antilocking system 14, which sends a signal indicating the operation of the antilocking system 14 to the control device 10; a sensor 16 for determining the speed of the front wheel of a one track vehicle such as a motorcycle (not illustrated); and a sensor 18 for determining the application of a brake. A typical brake light switch can be used, for example, as the sensor 18.

All sensors or units 12 to 18 transmit a corresponding signal to the control device 10. At this stage, the control device 10 is designed in such a manner that it can carry out a sequence of operations as shown below in FIG. 2. In the presence of specific conditions, an airbag activating signal is transmitted to an airbag unit indicated generally by arrow 20. The airbag unit 20 comprises a primer 24, which, in the activation process, operates a gas generator that inflates an airbag 22.

The operating mode of the control device 10 is explained in detail below with the aid of FIG. 2. Corresponding to FIG. 1, the sensor 18 transmits a signal to the control device 10, which determines whether the front wheel brake is applied (step S10). If this is the case, it is tested whether the antilocking system 14 reports an operation. Correspondingly, step S14 tests whether the wheel is locked and the brake pressure for avoiding lockage of the front wheel is reduced. If, despite the reduction of the brake pressure, a locked wheel is still registered, a suitable signal is transmitted to a logical OR element (S12). Furthermore, a signal is transmitted then to the OR element (S12), when the front wheel brake is not applied. From the OR link of step (S12), a signal is transmitted to an AND element (S18).

If, however, S14 determines that with a reduction in brake pressure the front wheel is no longer locked, an appropriate signal is transmitted to an OR element (S22).

The control device tests in parallel whether the value, determined by the front wheel sensor 16, indicates that the speed of the front wheel has dropped to zero (S16). If this is the case, then a signal is transmitted to the AND element S18. If this is not the case, then a signal is transmitted to the OR element (S22).

A parallel third step tests whether the signal, coming from the longitudinal acceleration sensor 12, exceeds a threshold value (S20). If this is the case, then a signal is transmitted to the AND element (S18). If this is not the case, a signal is transmitted to the OR element (S22).

If at this stage it is determined that the speed of the front wheel has dropped to zero, even though the front wheel brake has not been applied or, in the event the front wheel brake is being applied and the antilocking system is activated, then a signal is generated by the AND element (S18) to activate the airbag (S24).

If, in contrast, it is determined that upon applying the brake following a reduction in the brake pressure the locked wheel is released again or that the longitudinal acceleration is below a defined threshold value or that the speed of the wheel has not dropped to zero, no action is taken with respect to the activation of an airbag (S26).

In summary, it is thus possible to avoid a misactivation of the airbag.

Of course, other embodiments of the present invention are also possible. Essential to the invention is the consideration of a drop in the speed of the wheel to zero in the event the brake is not applied or in the event the brake is applied when the antilocking system is turned on, but the locked wheel is not released despite a reduction in the brake pressure.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A control system for activating an airbag in a one track vehicle, comprising:
a control device which receives and evaluates input signals, the control device generating an activation signal for the airbag in the presence of defined conditions;
a sensor for detecting one of front wheel revolutions and front wheel deceleration, the sensor generating one of said input signals;
a device that detects an application of a front wheel brake, said device generating one of said input signals;
wherein said control device permits, in addition to at least one other condition, the activation of the airbag only if the front wheel is decelerated essentially to zero in a case wherein the front wheel brake is not applied.

2. The control system according to claim 1, further comprising an antilocking system generating an activating signal, wherein the control device additionally activates the airbag if the front wheel is decelerated essentially to zero and the front wheel brake is applied but the antilocking system is activated.

3. The control system according to claim 2, further comprising a driving speed sensor determining whether a defined vehicle speed threshold value is exceeded, said defined vehicle speed threshold value being said at least one other condition.

4. The control system according to claim 3, wherein said defined vehicle speed threshold value is within a range of 5 to 20 km per hour.

5. The control system according to claim 1, further comprising an acceleration sensor determining whether a defined vehicle deceleration threshold value is exceeded, said defined vehicle deceleration threshold value being used as said at least one other condition.

6. The control system according to claim 2, further comprising an acceleration sensor determining whether a defined vehicle deceleration threshold value is exceeded, said defined vehicle deceleration threshold value being used as said at least one other condition.

7. The control system according to claim 3, further comprising an acceleration sensor determining whether a defined vehicle deceleration threshold value is exceeded, said defined vehicle deceleration threshold value being used as said at least one other condition.

8. The control system according to claim 4, further comprising an acceleration sensor determining whether a defined vehicle deceleration threshold value is exceeded, said defined vehicle deceleration threshold value being used as said at least one other condition.

9. A process for activating an airbag in a one track vehicle having a control device which receives and evaluates different input signals and generates an activation signal for the airbag in the presence of defined conditions, the process comprising the acts of:
detecting a speed of a front wheel of the vehicle or a deceleration of the front wheel of the vehicle;
detecting an activation of an antilocking system if present in the vehicle;
detecting an activation of a front wheel brake; and
generating the activating signal for the airbag if, in addition to at least one other condition, the front wheel is decelerated essentially to zero when the front wheel brake is not applied or, when the front wheel brake is applied, but the antilocking system is activated.

10. The process according to claim 9, wherein said at least one other condition is an exceeding of a defined speed threshold.

11. The process according to claim 9, wherein said at least one other condition is an exceeding of a defined deceleration threshold value.

12. The process according to claim 10, wherein said at least one other condition is an exceeding of a defined deceleration threshold value.
